(19) United States
(12) Patent Application Publication
(10) Pub. No.: US 2026/0101097 A1
(43) Pub. Date: Apr. 9, 2026

(54) Video Surveillance System and Method for Processing Video Streams with a Timestamp

(71) Applicant: Eagle Eye Networks, Inc., Austin, TX (US)

(72) Inventors: Sankaranarayanan Parameswaran, Bangalore (IN); Navaneethan Sundaramoorthy, Peelamedu (IN); Dean Drako, Austin, TX (US); Steven Roskowski, Austin, TX (US)

(73) Assignee: Eagle Eye Networks, Inc., Austin, TX (US)

(21) Appl. No.: 18/907,702

(22) Filed: Oct. 7, 2024

(51) Int. Cl. H04N 21/8547; G06V 20/52

(52) U.S. Cl. CPC H04N 21/8547; G06V 20/52

(57) ABSTRACT

A camera may capture images for a video stream and apply timestamps to the images. A bridge may receive the video stream and mask the timestamps to prevent the timestamps from triggering motion analyses. In the event the camera or a bridge corresponding to the camera loses connectivity with a data center, the camera may record all information locally. When the camera regains connectivity, the bridge may communicate images with their timestamps to the data center, wherein the data center synchronizes the different images and/or video streams received from a set of cameras based on timestamps in the stream metadata.

### BACKGROUND

### Field of the Disclosure

This disclosure relates generally to video surveillance systems and more particularly to systems and methods for processing images in a video stream having a timestamp.

### Description of the Related Art

In some systems, cameras capture video streams, automatically add a timestamp and store the video streams locally, wherein all analysis of a video stream may be performed locally. In other systems, video streams are communicated to a centralized server, wherein analyses may be performed at the centralized server.

### SUMMARY

Embodiments may be generally directed to a method for synchronizing video streams received at a data center communicatively coupled to a plurality of edge devices. The method may comprise receiving, by a processor associated with an edge device, a plurality of images corresponding to a video stream, wherein the video stream comprises a timestamp in an area within the plurality of images; in response to determining the edge device is not connected to the data center: storing the plurality of images in a memory associated with the edge device; in response to determining the edge device is reconnected to the data center; and communicating the plurality of images to the data center. A processor in the data center is configured to execute a set of instructions to perform: identifying a first plurality of images corresponding to the video stream; identifying a first timestamp for the first plurality of images; identifying a second plurality of images corresponding to the video stream; identifying a second timestamp for the second plurality of images; and determining a relationship between the first plurality of images and the second plurality of images based on the first timestamp and the second timestamp; and storing, in a memory, the first plurality of images and the second plurality of images based on the relationship.

In some embodiments, one or more of the first plurality of images and the second plurality of images depict an object in motion. In some embodiments, the object is a person. In some embodiments, the object is a vehicle. In some embodiments, identifying a first timestamp for the first plurality of images comprises identifying an area corresponding to a timestamp. In some embodiments, identifying an area corresponding to a timestamp comprises identifying one of a header or a footer. In some embodiments, the method further comprises determining a variable for masking; and masking the variable. In some embodiments, determining a variable for masking comprises determining one of an hour, a minute and a second variable. In some embodiments, masking the variable comprises positioning a box over the variable. In some embodiments, masking the variable comprises outlining the variable.

Embodiments may be generally directed to a system comprising a bridge coupled to an edge device and a data center. The bridge comprises a bridge memory storing a set of bridge instructions and a bridge processor configured to execute the set of bridge instructions to: receive a plurality of images from the edge device and determine whether the edge device is communicatively coupled to a data center server. If the edge device is connected to a data center server, the bridge is configured to communicate the plurality of images to the data center server; or if the edge device is not connected to the data center server, the bridge is configured to: record the plurality of images in the memory; determine when the edge device is connected to the data center server; and communicate the plurality of images from the memory to the data center server. The data center server comprises server memory storing a set of server instructions and a server processor configured to execute the set of server instructions to: receive the plurality of images from the bridge; identify a timestamp for the plurality of images; and store the plurality of images in the server memory based on the timestamp.

In some embodiments, the server processor executes the set of server instructions to determine the plurality of images depicts an object in motion. In some embodiments, the server processor executes the set of server instructions to determine the object in motion comprises a person. In some embodiments, the server processor executes the set of server instructions to determine the object in motion comprises a vehicle.

### BRIEF DESCRIPTION OF THE DRAWINGS

For a more complete understanding of the present disclosure and its features and/or advantages, reference is now made to the following description, taken in conjunction with the accompanying drawings, which are not drawn to scale, and in which:

FIG. 1 depicts a system architecture of one embodiment of a network for smart video surveillance;

FIGS. 2-7 depict embodiments of user systems for capturing information from cameras associated with user locations;

FIG. 8 is a diagram of an information handling system configurable for processing and storing information from cameras associated with user locations;

FIG. 9 depicts a video frame, illustrating header and footer areas wherein timestamps are commonly embedded;

FIGS. 10 and 11 depicts exemplary timestamps, illustrating variations in text size, text font and format;

FIG. 12 depicts a flow diagram, illustrating a method for processing images in a video stream having a timestamp;

FIG. 13 depicts the timestamp depicted in FIG. 11, illustrating masking comprising defining areas within a timestamp for reduced sensitivity. ; and

FIG. 14 depicts a closeup view of a character of the timestamp depicted in FIG. 10, illustrating masking comprising processing areas outside of boundaries of the character

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral refers to a class or type of entity, and any letter or hyphenated numeral following such reference numeral refers to a specific instance of a particular entity of that class or type. Thus, for example, a hypothetical entity referenced by ‘12A’ or ‘12-1’ may refer to a particular instance of a particular class/type, and the reference ‘12’ may refer to a collection of instances belonging to that particular class/type or any one instance of that class/type in general.

Video monitoring systems may be useful for monitoring a range of environments, wherein each environment includes one or more locations (e.g., indoors and outdoors, public and private, small and large) and a VMS may monitor for one various object types (e.g., persons, animals, objects, vehicles). Cameras may be positioned and oriented to capture images, embed a timestamp in the images and transmit the images to a data center for storage and further processing.

### System Overview

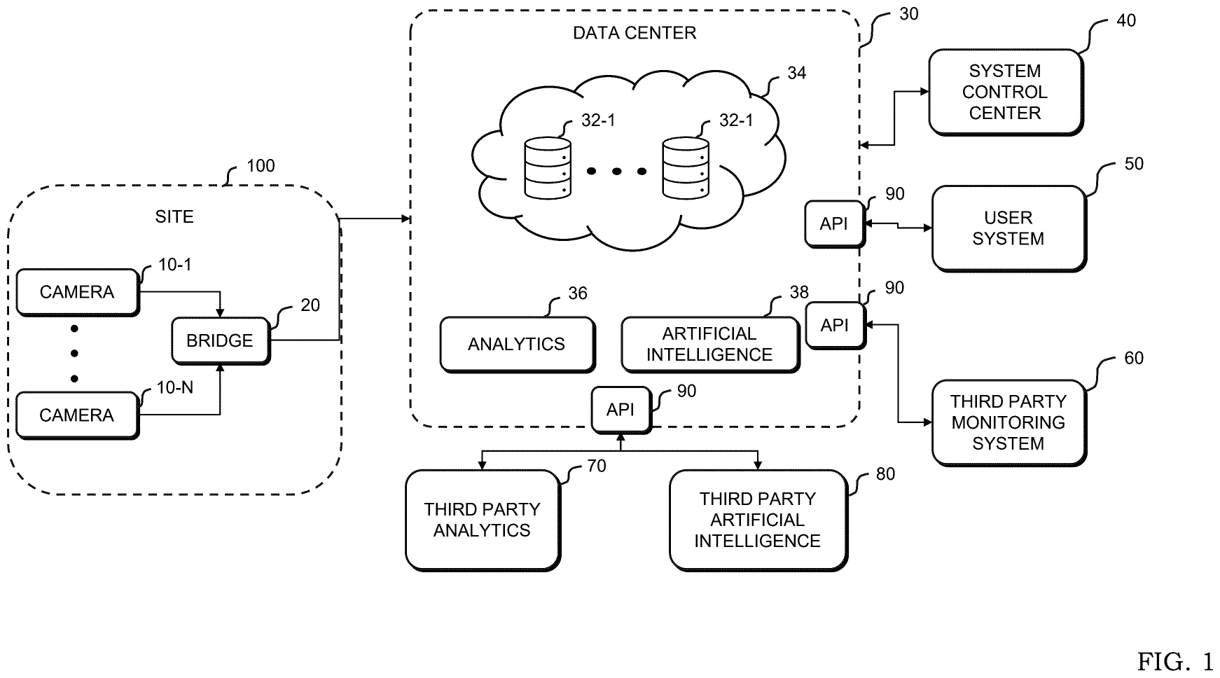

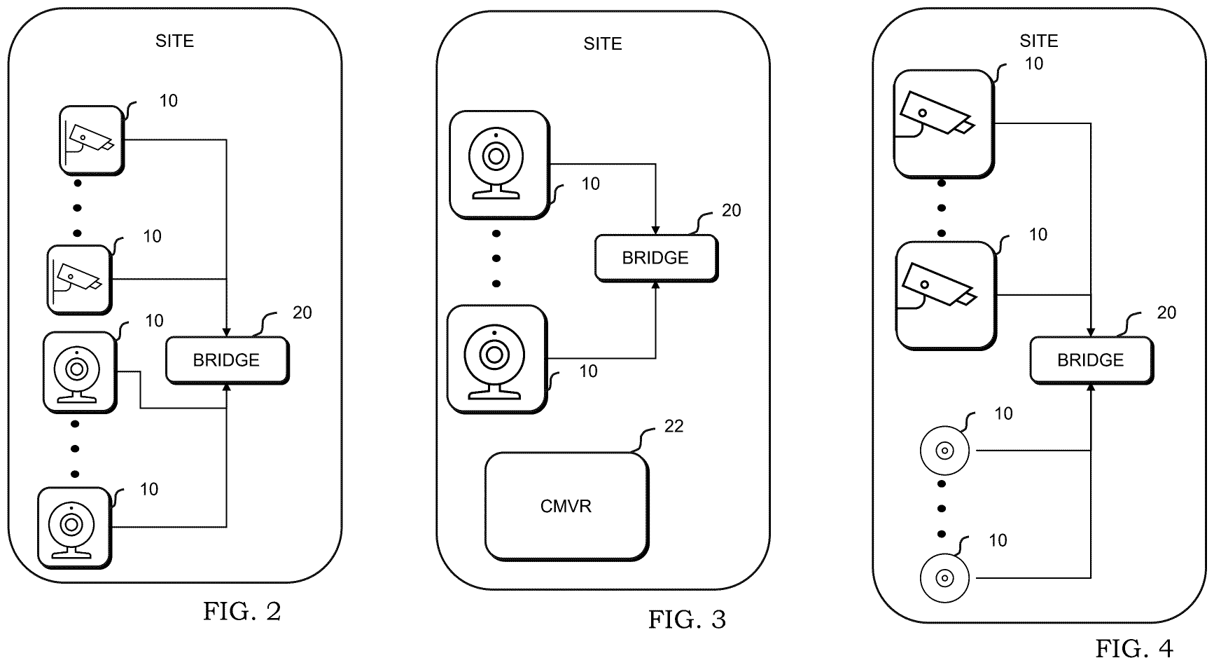

Turning to FIG. 1 and one or more of FIGS. 2-7, a system architecture of embodiments disclosed herein may comprise a plurality of cameras 10 at a user location 100 communicatively coupled to data center 30. In some embodiments, communicatively coupling a camera 10 to data center 30 may comprise a direct connection, wherein camera 10 communicates information directly to data center 30. In other embodiments, communicatively coupling a camera 10 to data center 30 may comprise an indirect connection, wherein camera 10 communicates information to bridge 20 (represented by dashed lines) and bridge 20 communicates the information to data center 30. Notably, one or more cameras 10 at user location 100 may communicate information directly to data center 30 and one or more cameras 10 may communicate information indirectly to data center 30.

Data center 30 may refer to a plurality of servers or other information handling systems configured for processing and storing information. Processing information may include, but is not limited to, receiving information, applying a time/date stamp, associating a user location with camera 10 providing the information, associating a user identifier with camera 10 providing the information, associating a geolocation with camera 10 providing the information, associating device information with camera 10 providing the information and associating a map or a floorplan with camera 10. Processing a video stream may also include applying artificial intelligence (AI) to the information and/or analyzing the information to determine a make, model, signature or description of a vehicle, determine a number and/or signature of one or more people associated with the information and determine one or more of a movement of a person, a movement of a part of a person or a gesture.

Data center 30 may comprise a single site or may comprise a collection of sites, wherein information (including video streams) received from cameras 10 may be received, processed and stored in a plurality of servers located at a single site or at multiple sites. Data center 30 may be communicatively coupled to system management center 40, one or more user systems 50 and one or more monitoring systems 60. Data center 30 may also be communicatively coupled to third party analytics server 70 and/or third-party artificial intelligence (AI) server 80. User systems 50, third-party monitoring systems 60, third-party analytics servers 70 and third-party AI servers 80 may be communicatively coupled to data center 30 through Application Programming Interfaces (APIs) 90.

### Cameras

Cameras 10-1 to 10-N may comprise analog and/or digital (e.g., Internet Protocol or “IP”) cameras 10 for capturing information relating to an environment, including, but not limited to, directional cameras 10, 360-degree cameras 10, fish-eye cameras 10, black-and-white video cameras 10, color cameras 10, high resolution cameras 10, low-resolution cameras 10 and/or infrared cameras 10 for capturing video information. One or more cameras 10 may comprise proprietary cameras 10 associated with Eagle Eye Networks, Inc. of Austin, Texas. In some embodiments, one or more cameras 10 may be manufactured by a third-party enterprise. Cameras 10 may be located inside or outside a structure (e.g., an office building, a school or a warehouse) or near an area (e.g., near elevators or an entrance to a building, near a playground, in a park or in a parking lot). Referring to FIG. 6, in some embodiments, cameras 10 and/or bridge 20 may be located in vehicle 90 with mobile network device 92 configured to communicate with data center 30 over a network (e.g., cellular or Wi-Fi).

Cameras 10 may be positioned and oriented to capture information including video streams. For example, cameras 10 may be positioned and oriented to detect people and/or cameras 10 may be positioned and oriented to detect vehicles entering/exiting an area. Cameras 10 may automatically embed timestamps, discussed in greater detail below.

### Bridges

Bridge 20 comprises a processor and memory storing instructions executable by the processor to receive information from one or more cameras 10 and communicate the information to data center 30. Information may include a video stream as well as information related to the video stream (also referred to as “metadata”). For example, information may comprise a video stream and metadata including when and where the video stream was recorded. Metadata may also include, for example, environmental conditions (e.g., a temperature reading or a sound level) and camera information (e.g., a make/model, resolution, etc.).

In some embodiments, bridge 20 may communicate with multiple cameras 10 to receive multiple data streams and communicate with data center 30 to transmit one or more video streams with metadata for the video streams. In some embodiments, bridge 20 may receive information from one or more cameras 10 and directly communicate the information to data center 30. In some embodiments, bridge 20 may receive information from one or more cameras 10 and analyze or process at least a portion of the information before communicating the information to data center 30. In some embodiments, bridge 20 may receive information from one or more cameras 10 and store at least a portion of the information before communicating the information to data center 30. Thus, communicatively coupling cameras 10 to bridges 20 and communicatively coupling bridges 20 to data center 30 may refer to directly or indirectly communicating information from cameras 10 to data center 30, communicating information from cameras 10 through bridges 20 to data center 30, and/or analyzing, processing or storing at least a portion of the information before communicating the information to data center 30. Embodiments of bridge 20 may be configured to communicate information to data center 30 in real-time, based on time (e.g., at scheduled intervals or at a scheduled time) or based on an event (e.g., in response to a predefined trigger or regaining connectivity).

In some embodiments, bridges 20 may be configured to receive a video stream from a camera 10 and determine whether to send the video stream to data center 30. Determining whether to send a video stream to data center 30 may be based on some criteria. In some embodiments, bridges 20 may be configured to receive a video stream from a camera 10, detect motion in the video stream, and determine, based on the motion, whether to send the video stream to data center 30.

### Data Centers

Still referring to FIG. 1, data center 30 may comprise a plurality of data storage servers 32, wherein multiple data storage servers 32 may be collectively referred to as cloud 34. Each data storage server 32 has memory and a processor for receiving, storing and accessing video streams and other information received from bridges 20. In some embodiments, data center 30 may be configured to store information received from a single camera 10 of the plurality of cameras 10 in at least three separate data storage servers 32 for redundant storage. Data center 30 may include analytics server 36 and artificial intelligence (AI) server 38, discussed in greater detail below.

### Data Center Information Processing

In some embodiments, information processing may comprise analyzing video streams from one or more cameras 10. For example, analyzing video streams may include determining a manufacturer of camera 10 and a set of characteristics of camera 10 (e.g., a minimum illumination threshold), a maximum threshold (e.g., maximum illumination threshold), a resolution of camera 10, a frames per second (FPS) processing speed of camera 10, a latency of camera 10, a transmission protocol, or some other information associated with the capabilities of camera 10 for recording and transmitting information. Camera information may also include, for example, information on a location of camera 10, wherein location information may include absolute information (e.g., geo-positioning system or GPS information) and/or relative location information (e.g., “the north stairwell”). Camera information may include, for example, azimuth or orientation information, wherein orientation information may comprise absolute information (e.g., angled at 45 degrees horizontally and −25 degrees vertically) and/or relative information (e.g., “angled towards the stairwell and looking down”). Camera information may include, for example, a time, a date and/or other information to identify where and when information was captured. Camera information may include network information, such as an Internet Protocol (IP) address and/or an alias (e.g., “the main lobby camera”).

Analytics server 36 has memory and a processor executing instructions to analyze information received from bridges 20.

Artificial intelligence (AI) server 38 has memory and a processor executing instructions to process information received from bridges 20. Processing information from bridges 20 may include, but is not limited to, determining whether there is motion in a video stream, identifying an object in a video stream, determining whether there is a timestamp in a video stream and/or determining whether motion in a timestamp corresponds to a timestamp.

### Information Handling Systems

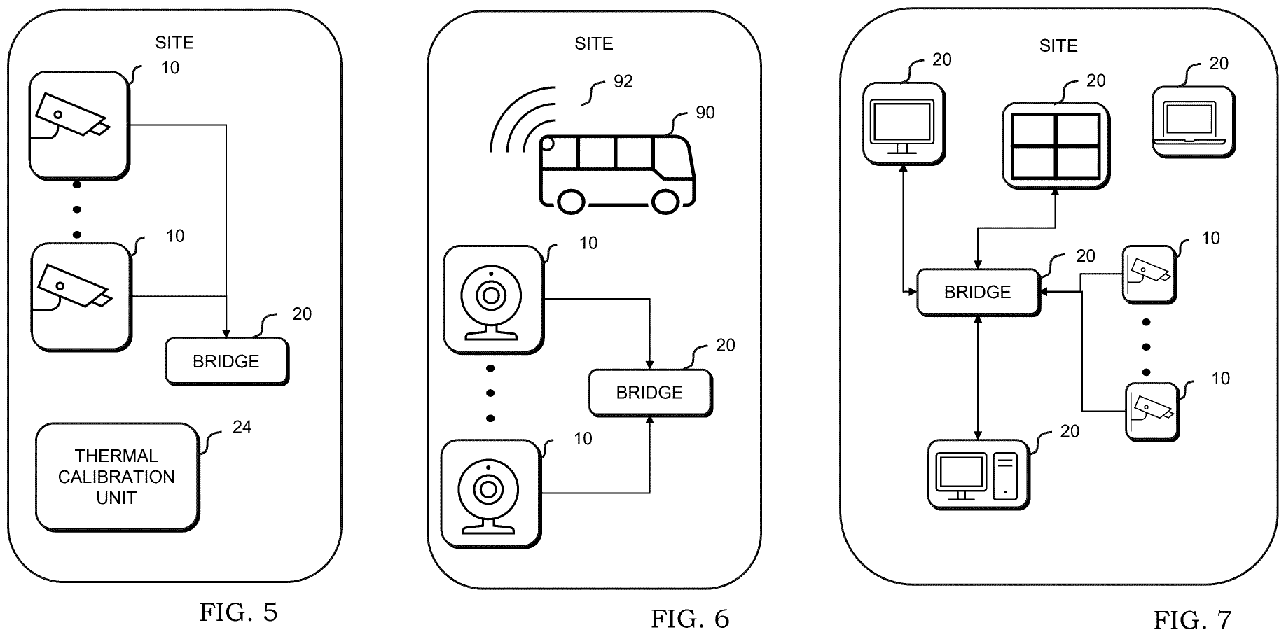

Referring to FIG. 8 and one or more of FIGS. 1, 6 and 7, data center 30, system control center 40, user system 50, third-party systems 60, third-party analytics 70 and third-party artificial intelligence (AI) systems 80 may comprise embodiments of information handling systems 800. FIG. 8 depicts an information handling system 800 capable of administering several of the embodiments of the present disclosure. Information handling systems 800 include processor subsystem 802 communicatively coupled via system bus 810 to memory subsystem 820, input/output (I/O) subsystem 830 and network interface 840.

Processor subsystem 802 comprises a system, device, or apparatus operable to interpret and execute program instructions and process data, and may include a microprocessor, microcontroller, digital signal processor (DSP), application specific integrated circuit (ASIC), or another digital or analog circuitry configured to interpret and execute program instructions and process data. In some embodiments, processor subsystem 802 may interpret and execute program instructions and process data stored locally (e.g., in memory subsystem 820). In the same or alternative embodiments, processor subsystem 802 may interpret and execute program instructions and process data stored remotely (e.g., in a network storage resource). Processor subsystem 802 may include components such as a central processing unit (GPU), a graphics processing unit (GPU) and/or a neural processing unit (NPU), for example.

System bus 810 may refer to a variety of types of bus structures, e.g., a memory bus, a peripheral bus, or a local bus, using various bus architectures in selected embodiments. For example, bus architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

Memory subsystem 820 may comprise a system, device, or apparatus (e.g., computer-readable media) operable to retain and retrieve program instructions and data for a period. Memory subsystem 820 may comprise one or more volatile storage 824 and persistent storage 826. Storage may comprise random access memory (RAM), electrically erasable programmable read-only memory (EEPROM), a PCMCIA card, flash memory, magnetic storage, opto-magnetic storage or a suitable selection or array of volatile or non-volatile memory that retains data after power is removed.

I/O subsystem 830 comprises a system, device, or apparatus operable to receive and transmit data to or from or within information handling system 800. I/O subsystem 830 may represent, for example, a variety of communication interfaces, graphics interfaces, video interfaces, user input interfaces, and peripheral interfaces. In various embodiments, I/O subsystem 830 may be used to support various peripheral devices, such as a touch panel, a display adapter or a keyboard, among other examples. In some implementations, I/O subsystem 830 may support so-called ‘plug and play’ connectivity to external devices, in which the external devices may be added or removed while information handling system 800 is operating. In some embodiments, information handling system 800 may further include display 832. Display 832 may be of a variety of display types, such as a liquid crystal display (LCD), an organic light emitting diode (OLED), a flat panel display, a solid-state display, or a cathode ray tube (CRT). Display 832 may include one or more touch screen display modules and touch screen controllers for receiving user inputs to information handling system 800. Additionally, information handling system 800 may include an input device, such as a keyboard, and a cursor control device, such as a mouse or touchpad or similar peripheral input device.

Network interface 840 may be a suitable system, apparatus, or device operable to serve as an interface between information handling system 800 and a network (not shown). Network interface 840 may enable information handling system 800 to communicate over the network using a suitable transmission protocol or standard. In some embodiments, network interface 840 may be communicatively coupled via the network to a network storage resource (not shown). The network coupled to network interface 840 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and messages (generally referred to as data). The network coupled to network interface 840 may transmit data using a desired storage or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), or any combination thereof. The network coupled to network interface 840 or various components associated therewith may be implemented using hardware, software, or any combination thereof.

Still referring to FIG. 8, computer program product 860 may comprise computer-readable media 870 storing program code 862. Program code 862 may be loaded onto or transferred to information handling system 800 for running by processor subsystem 802.

### Cameras Automatically Embed Timestamps in Video Streams

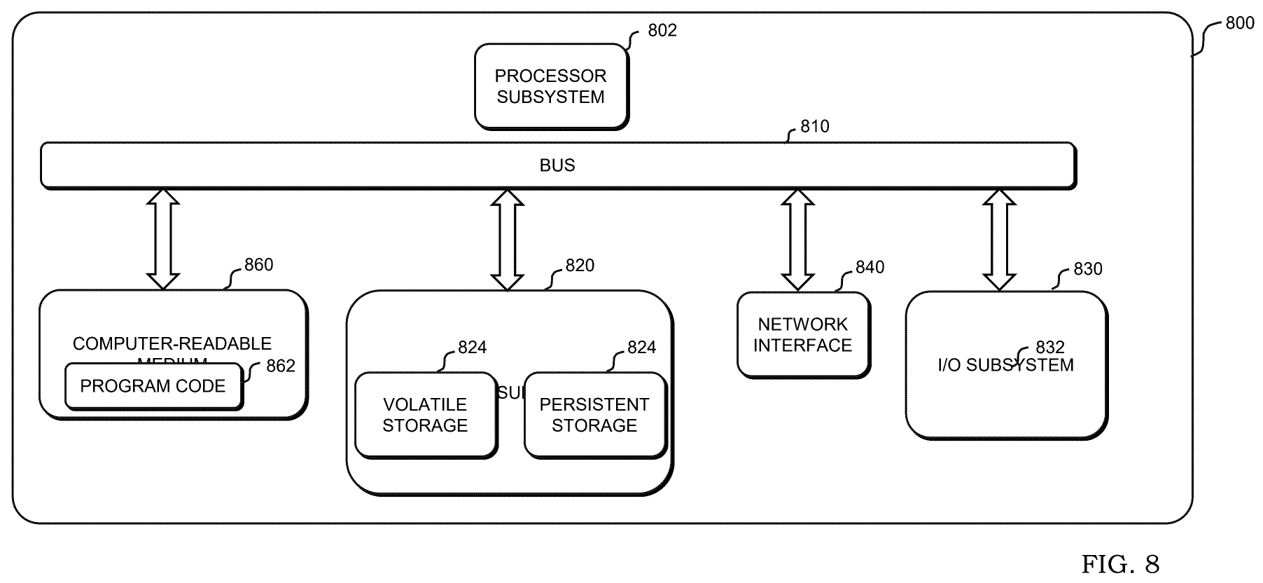

Referring to FIG. 9, when cameras 10 capture video stream 900 containing a plurality of images 902, cameras 10 may automatically embed a timestamp in area 904 on each image 902. Video surveillance systems analyze video stream 900 with images 902 having area 904 associated with a timestamp, wherein area 904-1 may be a header and area 904-2 may be a footer, for example. Areas 904 may span a width of image 902, wherein the width may be less than or equal to a total width of image 902. In some embodiments, area 904 may be centered within a width of image 902 or may be offset (e.g., a top left portion of area 904-1, a top right portion of area 904-1, a bottom left portion of area 904-2 or a bottom right portion of area 904-2). The size of area 904 may depend on one or more properties of a timestamp embedded in the image 902.

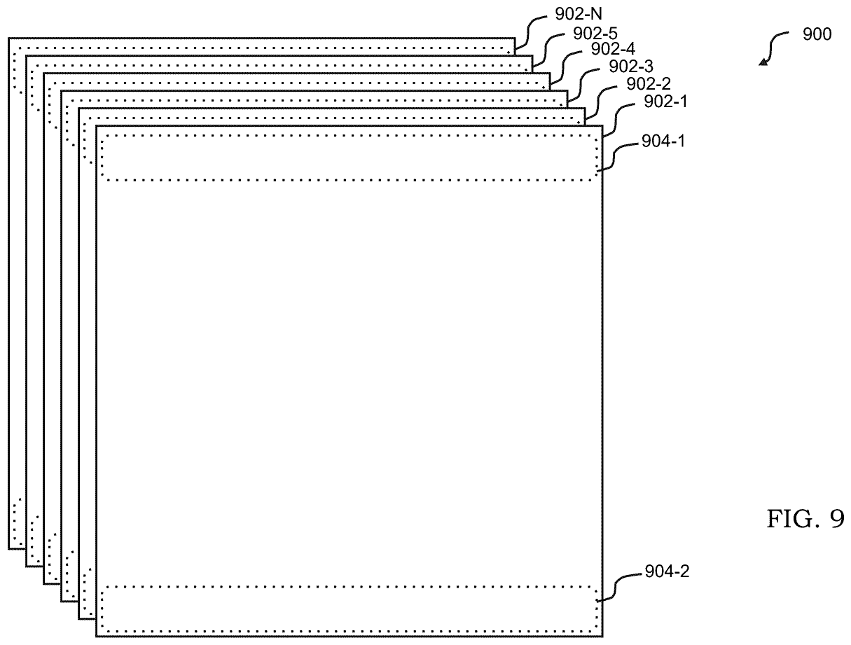

Referring to FIGS. 10 and 11, images 902 may be embedded with different timestamps 1000, wherein timestamps 1000 may have different text sizes, text colors, text spacing, text order (e.g., DDMMYYYY, YYYYMMDD, DDMMMYYYY, etc.) and text content (e.g., time only, time+day, time+date, etc., wherein time may include HH:MM:SS, HH:MM:SS.SS, etc.) and may be in different locations within an image 902 (e.g., header 904-1 or footer 904-2, including centered, left-justified, right-justified, etc.). As shown in FIG. 10, timestamp 1000-1 may have a first format (e.g., Orbitron font, large font, DTG (Date-Time Group) format HH: MM. SS). As shown in FIG. 11, timestamp 1000-2 may have a second format (e.g., Silkscreen font, medium font, and DTG format <MM:HH.SS, MONTH DAY, YEAR>). Comparing timestamp 1000-1 with timestamp 1000-2, both have text 1002,1102 and openings 1004, 1104 in some text 1002, 1102. However, due to the format of text 1002, 1102, timestamps 1000-1 and 1000-2 may differ in size and other characteristics. For example, timestamp 1000-2 is longer than timestamp 1000-1 and may have larger openings 1004-2 than openings 1004-1.

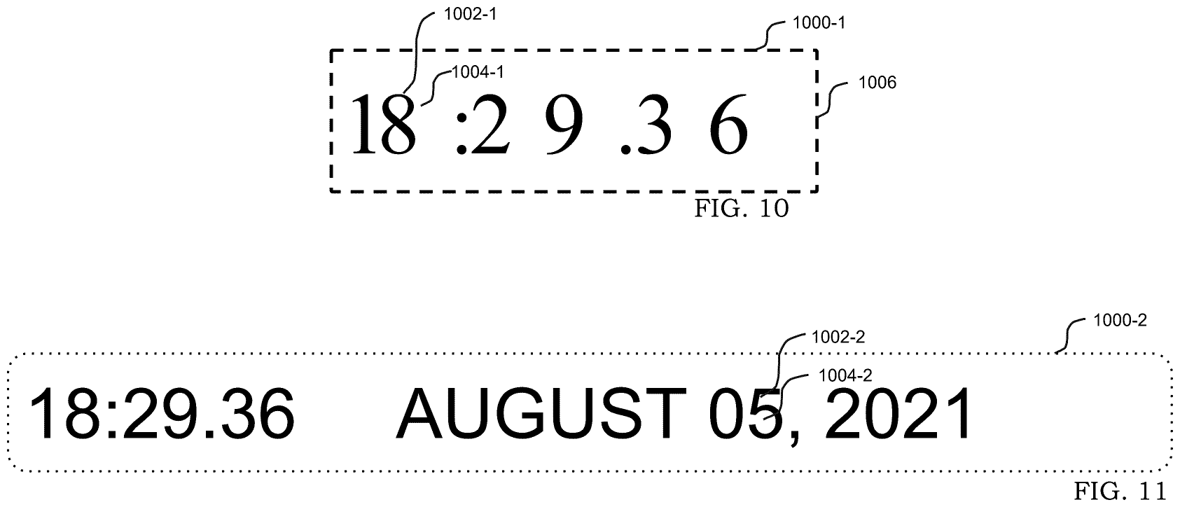

FIG. 12 depicts a flow diagram illustrating an embodiment of a method for processing video streams with timestamps.

At step 1202, camera 10 captures images 902 in a video stream 900. In some embodiments, camera 10 may be configured to continually capture images 902.

At step 1204, camera 10 may embed timestamp 1000 in images 902 in video stream 900. Steps 1202 and 1204 may repeat continuously, regardless of any remaining steps.

At step 1206, processor 802 in bridge 20 may execute a set of instructions to determine if there is motion in header or footer areas 904 in images 902. Processor 802 may execute instructions to use artificial intelligence or analytics to identify motion.

At step 1208, if bridge 20 determines there is motion in header or footer areas 904 in images 902 in video stream 900, bridge 20 may mask a portion of area 904, discussed in greater detail below.

At step 1210, regardless of whether bridge 20 determines there is motion in areas 904, bridge 20 may determine if selected objects are present in video stream 900. For example, processor 802 in bridge 20 may execute one or more sets of instructions to determine if images 902 in video stream 902 contain persons, animals or vehicles.

At step 1212, if processor 802 in bridge 20 determines selected objects are present in images 902 in video stream 900, processor 802 may automatically forward the video stream 900 to data center 30.

Alternatively, at step 1214, if processor 802 in bridge 20 determines there are no selected objects present in images 902 in video stream 900, processor 802 may not forward the video stream 900 to data center 30. Additional processing by bridge 20 may be performed, which may result in video stream 900 being forwarded to data center 30.

### Timestamp Masking

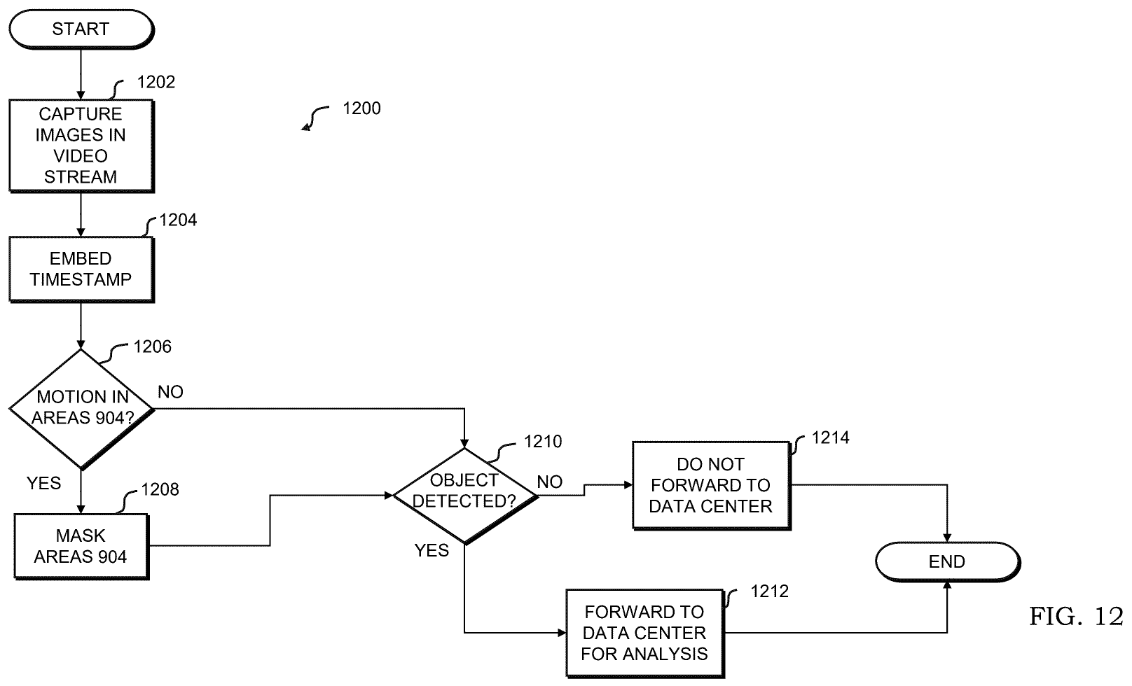

Referring to FIG. 13, in some embodiments, masking timestamps 1000 may involve obfuscating all or a portion of timestamps 1000. As depicted in FIG. 13, processor 802 in bridge 20 may execute a set of instructions to overlay boxes 1310 on all or a portion of timestamp 1000-2. Box 1310-1 may correspond to “hours” variable, box 1310-2 may correspond to “minutes” variable, box 1310-3 may correspond to “seconds” variable, box 1310-4 may correspond to “month” variable, box 1310-5 may correspond to “day” variable, and box 1310-6 may correspond to “seconds” variable, for example. Box 1310 may be configured to obfuscate a variable, wherein obfuscating a variable may include blacking out or redacting a variable and may include blurring a variable.

### Adjusting Sensitivity

Not all of timestamp 1000 may need to be masked by box 1310-1. For example, a “year” variable of timestamp 1000 will only change once per year and any motion corresponding to updating the “year” variable of timestamp 1000-2 will be less than one second. By contrast, the “seconds” variable of timestamp 1000-2 will change every second and “fractions of a second” variable 1310-3 will change every 10th of a second, 100th of a second or thousandth of a second. Thus, parts of timestamp 1000-2 may change almost constantly, while other parts may change hourly, daily, monthly or annually. Embodiments may be configured to adjust sensitivity, wherein processor 802 may be configured to detect motion that lasts more than a threshold time period. In some embodiments, processor 802 may be configured to execute a set of instructions to detect motion that lasts more than a threshold time period within an area 904. Thus, processor 802 may detect motion that lasts more than a first threshold time period (e.g., the first time period may be less than one second) within an area 904 and configured to detect motion that lasts more than a second threshold time period (e.g., the second time period may be greater than one second) for image 902.

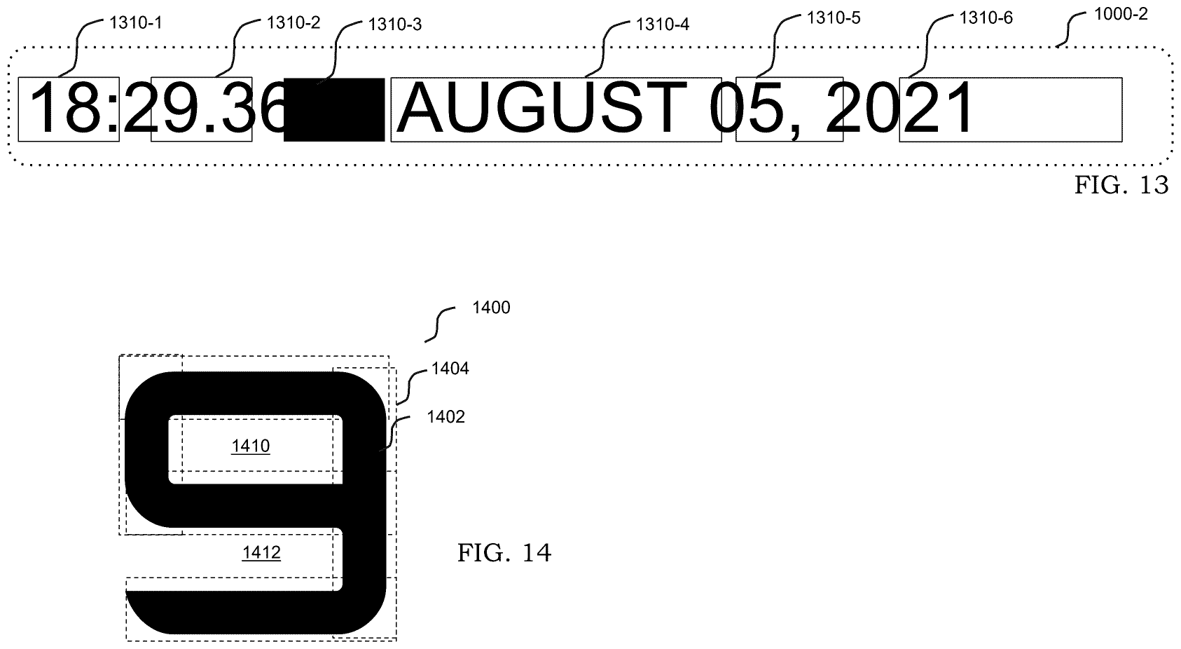

Referring to FIG. 14, in some embodiments, masking timestamps 1000 may involve defining portions of a character 1400 in which motion is not detected. For example, FIG. 14 depicts character 1400 (e.g., the numeral “9”) defined by lines 1402 outlined by a plurality of boxes 1404. Lines 1402 and boxes 1404 may define character areas 1410-1 and 1410-2 in which lines 1402 would not hide motion. In some embodiments, processor 802 in bridge 20 may execute a set of instructions to analyze images 902 to determine if motion is occurring inside character areas 1410.

### Synchronizing Video Streams Based on Timestamps in Video Stream Metadata

In some situations, timestamps communicated with video streams 900 as metadata may be advantageous for further processing. For example, bridge 20 at a site may lose connectivity with data center 30. Bridge 20 may be configured to record images 902 of video stream 900 locally (e.g., in response to determining bridge 20 has lost connectivity with data center 30) and transmit images 902 from video streams 900 (e.g., when connectivity is restored). If a site has a single camera 10 with a single video stream 900, embodiments might not need to synchronize video streams 900. However, if there are multiple cameras 10 capturing multiple data streams 900 and one camera 10 loses connectivity, embodiments may synchronize all the video streams 900 once connectivity is restored. Embodiments may analyze stream metadata for a video stream 900 to identify a timestamp and compare timestamps from different stream metadata from different bridges 20 and/or cameras 10 to determine related images 902.

For example, embodiments may receive a first video stream of a person walking in a building and receive a second video stream of a person walking around the building but determine, based on timestamps in the stream metadata, that the person walked around the building before they entered the building. As another example, embodiments may receive a first video stream from a first camera 10-1 directed at a first angle toward a parking garage and receive a second video stream from a second camera 10-2 directed at a second angle toward a parking garage. The first video stream might be viewed from the front of the vehicle and the second video stream might be viewed from the rear of the vehicle. Using timestamps in the stream metadata, embodiments may determine the two video streams are of the same vehicle.

A method for synchronizing video streams 900 received at data center 30 communicatively coupled to a plurality of cameras 10 may comprise receiving, by a processor 802 associated with one or more cameras 10, a plurality of images 902 corresponding to one or more video streams 900, analyzing metadata associated with each video stream 900 to identify a timestamp, and determining an order of the plurality of video streams 900 or images 902 based on the order of the timestamps.

In some embodiments, in response to determining that a camera 10 or bridge 20 is not connected to data center 30, processor 802 may store a plurality of video streams 900 and/or images 902 in memory 820. In response to determining camera 10 and/or bridge 20 is reconnected to data center 30, processor 802 may communicate the plurality of video streams 900 and/or images 902 to data center 30, wherein processor 802 in data center 30 may be configured to execute a set of instructions to identify a first plurality of images 902 corresponding to the video stream 900; identify a first timestamp in video metadata for the first plurality of images 902; identify a second plurality of images 902 corresponding to video stream 900; identify a second timestamp in video metadata for the second plurality of images 902; and determine a relationship between the first plurality of images 902 and the second plurality of images 902 based on the first timestamp and the second timestamp; and store, in memory 820 in data center 30, the first plurality of images 902 and the second plurality of images 902 based on the relationship.

In some embodiments, one or more of the first plurality of images 902 and the second plurality of images 902 depict an object in motion, wherein the object may be a person or a vehicle. Motion may last a few milliseconds to seconds, minutes or longer. Motion may correspond to a person walking, running or otherwise translating across images 902 or may include the person standing up, sitting down or otherwise remaining in generally the same location but changing positions or may include the person waving or otherwise gesturing. Motion may also comprise a vehicle (including a bicycle, a motorcycle, car, truck, etc.) moving. Motion may also comprise an object moving, such as a ball rolling, or a tree swaying in the wind.

Thus, embodiments disclosed herein may reduce the volume of images 902 communicated to data center 30 by not sending images 902 that only have motion in areas 904. Furthermore, embodiments may mask images 902 with character boxes 1310 to reduce the analysis needed to determine if motion detected in areas 904 in images 902 corresponds to objects or timestamps 1000. However, video streams 900 with images 902 having timestamps 1000 may still be synchronized using timestamps 1000 when connectivity is restored.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is

1. A method for synchronizing video streams received at a data center communicatively coupled to a plurality of edge devices, the method comprising:
receiving, by a processor associated with an edge device, a plurality of images corresponding to a video stream, wherein the video stream comprises a timestamp in an area within the plurality of images;
in response to determining the edge device is not connected to the data center:
storing the plurality of images in a memory associated with the edge device;
in response to determining the edge device is reconnected to the data center:
communicating the plurality of images to the data center, wherein a processor in the data center is configured to execute a set of instructions to perform:
identifying a first plurality of images corresponding to the video stream;
identifying a first timestamp for the first plurality of images;
identifying a second plurality of images corresponding to the video stream;
identifying a second timestamp for the second plurality of images; and
determining a relationship between the first plurality of images and the second plurality of images based on the first timestamp and the second timestamp; and
storing, in a memory, the first plurality of images and the second plurality of images based on the relationship.

2. The method of claim 1, wherein one or more of the first plurality of images and the second plurality of images depict an object in motion.

3. The method of claim 2, wherein the object is a person.

4. The method of claim 2, wherein the object is a vehicle.

5. The method of claim 1, wherein identifying a first timestamp for the first plurality of images comprises identifying an area corresponding to a timestamp.

6. The method of claim 1, wherein identifying an area corresponding to a timestamp comprises identifying one of a header or a footer.

7. The method of claim 1, further comprising:
determining a variable for masking; and
masking the variable.

8. The method of claim 7, wherein determining a variable for masking comprises determining one of an hour, a minute and a second variable.

9. The method of claim 7, wherein masking the variable comprises positioning a box over the variable.

10. The method of claim 7, wherein masking the variable comprises outlining the variable.

11. A system, comprising:
a bridge coupled to an edge device, wherein the bridge comprises a bridge memory storing a set of bridge instructions and a bridge processor configured to execute the set of bridge instructions to:
receive a plurality of images from the edge device;
determine whether the edge device is communicatively coupled to a data center server, wherein:
if the edge device is connected to a data center server, the bridge is configured to communicate the plurality of images to the data center server; or
if the edge device is not connected to the data center server, the bridge is configured to:
record the plurality of images in the bridge memory;
determine when the edge device is connected to the data center server; and
communicate the plurality of images from the bridge memory to the data center server,
wherein the data center server comprises server memory storing a set of server instructions and a server processor configured to execute the set of server instructions to:
receive the plurality of images from the bridge;
identify a timestamp in stream metadata for the plurality of images; and
store the plurality of images in the server memory based on the timestamp.

12. The system of claim 11, wherein the server processor executes the set of server instructions to determine the plurality of images depicts an object in motion.

13. The system of claim 12, wherein the server processor executes the set of server instructions to determine the object in motion comprises a person.

14. The system of claim 12, wherein the server processor executes the set of server instructions to determine the object in motion comprises a vehicle.

15. A system, comprising:
a bridge coupled to a plurality of cameras, wherein the bridge comprises a bridge memory storing a set of bridge instructions and a bridge processor configured to execute the set of bridge instructions to:
receive a plurality of images from the plurality of cameras;
determine whether the camera is communicatively coupled to a data center server, wherein:
if the camera is connected to a data center server, the bridge is configured to communicate the plurality of images to the data center server; or
if the camera is not connected to the data center server, the bridge is configured to:
record the plurality of images in the bridge memory;
determine when the camera is connected to the data center server; and
communicate the plurality of images from the bridge memory to the data center server,
wherein the data center server comprises server memory storing a set of server instructions and a server processor configured to execute the set of server instructions to:
receive the plurality of images from the bridge;
identify a timestamp in stream metadata for the plurality of images; and
store the plurality of images in the server memory based on the timestamp.

16. The system of claim 15, wherein the server processor executes the set of server instructions to determine the plurality of images depicts an object in motion.

17. The system of claim 12, wherein the server processor executes the set of server instructions to determine the object in motion comprises a person.

18. The system of claim 12, wherein the server processor executes the set of server instructions to determine the object in motion comprises a vehicle.
